(19) United States
(12) Patent Application Publication
(10) Pub. No.: US 2008/0291850 A1
(43) Pub. Date: Nov. 27, 2008

(54) Systems and Methods for Power Line Communication with Refrigeration Containers

(75) Inventor: Bent Hyrup Jensen, Tranbjerg J (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: JOHNSON CONTROLS DENMARK APS, Hoejbjerg (DK)

(21) Appl. No.: 12/094,944

(22) PCT Filed: Nov. 24, 2006
(86) PCT No.: PCT/DK2006/000659

§ 371 Date: May 23, 2008

(30) Foreign Application Priority Data
Nov. 25, 2005 (DK) PA 2005 01661

(51) Int. Cl. H04L 5/14

(52) U.S. Cl. 370/276

(57) ABSTRACT

The present invention relates to systems and methods for power line communication primarily with refrigeration containers, where the communication to and from the containers is performed as modulated signals transmitted over the power line. It is the object of the invention to achieve effective communication to and from containers without risk of disturbance of the communication when a high number of containers are connected to the same power grid. This can be achieved if the systems comprise at least one module for power line communication, which module comprises means for transmitting the modulated signal to and from the power grid, which means comprises at least one magnetic core, which surrounds the power lines, which magnetic core comprises a secondary winding, which is connected to the power line communication system. It can hereby be achieved that there is no direct electrical connection to the power lines where these power lines pass through the communication module, hi this way, a total galvanic isolation towards the power lines will exist, and as such this will protect the module against a great part of the impairment that might exist on the power grid lines. This impairment could be high voltage sparks that otherwise could destroy or at least disturb the electronic circuit, hi the module, the use of safety circuits is as such partly avoided which safety circuits typically are used for short cutting high voltage sparks which are typically occurring over the grid where this high voltage is generated by in and out-coupling transformers.

### FIELD OF THE INVENTION

The present invention relates to systems and methods for power line communication primarily with refrigeration containers, where a number of containers can be connected to a power grid, where the systems comprise means for bidirectional communication with some of the containers, where some of the containers comprise means for communication with the systems, where the communication to and from the containers is performed as modulation of a signal transmitted over the power grid.

### BACKGROUND OF THE INVENTION

U.S. Pat. No. 4,885,563 concerns a power line carrier communication system having a carrier current transceiver (cct) interface with an electrical power line via a buffer which automatically provides a low output drive impedance while transmitting, and a high receiving impedance when receiving, all with solid state circuitry. The length of signal transmission by the cct is monitored and automatically prevented from continuously loading the communication network in the event of a malfunction which causes a signal transmission to exceed normal maximum transmission time. Prevention of continuous loading of the communication circuit is accomplished without adverse affect on the cct via a crowbar circuit connected to the buffer circuitry.

U.S. Pat. No. 4,885,564 also concerns a power line carrier communication system for monitoring refrigerated containers which includes a master monitoring unit and a first power line interface which interchange messages in a first format. The first power line interface translates the first format to a second format suitable for power line environment, and messages in the second format are applied to a power line. Remote monitoring units receive the messages from the power line, and they return messages to the power line containing status data relative to refrigerated containers. The second format includes a message starting preamble having a duration and logic level which is not duplicated by normal operation of the apparatus, enhancing the probability of proper message synchronization and reception over noisy power line environments.

U.S. Pat. No. 4,896,277 also concerns a method of mapping addresses of a plurality of refrigerated containers having remote monitoring units (rmus) connected to a power line carrier based monitoring system which includes a master monitoring unit (mmu). The method adapts to the size of the expected number of containers to be mapped by any mapping command, to reduce the overall time to map either a large or small number of containers. The method includes the mmu selecting a modulo having a magnitude determined by the number of containers expected to be mapped, and the rmus generating a random number within the range responsive to the modulo. The rmus apply response messages to the power line, which include the addresses of the associated containers, at a time responsive to the magnitude of the random number.

U.S. Pat. No. 5,973,610 concerns refrigerating containers (reefers) disposed in a seaboard terminal or onboard a ship and with a power supply via cables is monitored by means of built-in equipment and communicates via the power supply network) via an intermediate station with a central monitoring station. In case, disturbances on the power supply network causes unreliable data transmission, the system automatically selects an alternative communications path via another of the intermediate stations.

The invention described in U.S. Pat. No. 5,973,610 relates to a system for automated selection of a communication unit for refrigerating containers which acts as an intermediate station between a refrigerating container unit which is to be monitored and a central monitoring station where all refrigerating containers as power consumers and transmitters/receivers are connected to the power supply grid using coded messages.

The international standard ISO 10368 (freight thermal containers—remote condition monitoring) regulates the manner in which a single central monitoring station exchanges information by means of power cables with a number of communication units, modems, which is fitted into refrigeration containers placed onboard ships. The purpose of this is to perform central monitoring of the climatic conditions in the individual refrigeration containers and when needed to perform changes in the otherwise local control of refrigeration power, blowers, etc. Using the terminology of the international standard mentioned above and according to a recommended design, an mmu (master monitoring unit) is used as a central monitoring station which via an hccu or lccu (high and low data rate central control unit, respectively) communicates with several rcds (remote communication devices) which are each closely related to a refrigeration container.

A refrigeration container with a communication unit has a permanent identification code. However, in practice it has turned out that in larger areas, it is not sufficient to rely on the communication which may be transmitted on varying cable lengths from the individual container to the central monitoring station, and hence intermediate stations are used which each have the possibility to monitor a number of refrigeration containers and to communicate with the central monitoring station or a network of central monitoring stations. These provide the opportunity for an improvement in the reliability of the communication, which has not been realized until now. When deposing and connecting a refrigeration container to the power grid, in practice one would not wish to perform a manual identification of it towards the system nor would one wish to be tied to a communication protocol for deposing, such as filling up an area in a seaboard terminal in any particular order. This would also be in conflict with the desire to distribute the refrigeration containers while taking the stability of a ship into account, a distribution which is performed by a central inventory control system is dependent on the knowledge of the contents of the individual refrigeration containers.

U.S. Pat. No. 5,835,005 concerns a power line data transmission system for refrigerated container carrier systems which establish a direct link between an associated node and a target station node or searches for a relay station node based on the communication status of an associated node and a target node. When a sending station intends to transmit data to a target station to which the sending station cannot establish a direct link, the sending station searches for a station, i.e., a relay station which can communicate with the target station by retrieving a communication possible/impossible node list.

The power line data transmission system described in U.S. Pat. No. 5,835,005 is only to be used if the total number of containers is limited to maybe 2000. If a high number of containers communicate over the same power grid, interference between signals and noise disturbs the communication so that most of the signals must be retransmitted several times. This way all communication might be blocked. This situation could occur on both large container ships or in container yards.

US 2003/0190110 concerns an electrically “closed” method and apparatus for transmitting and receiving data signals over a high voltage power line. Inductive coupling is employed for coupling and decoupling the data signal directly onto and off a single power line wire. An exemplary device includes a high frequency inductive coupling toroid for data signals, a second (50-60 Hz) inductive coupling toroid for providing power, signal conditioning electronics for the receiving and transmitting of signals, a fibre-optics interface for electrical isolation purposes, and a weather-proof enclosure. According to a preferred embodiment the toroids are hinged to ease the installation on a power line. A pair of such couplings on either side of a fibre-optic isolator can be used to bridge transformers.

### OBJECT OF THE INVENTION

It is the object of the invention to achieve effective communication to and from containers without the risk of disturbance of the communication from impairments applied when a high number of containers are connected to the power grid.

### DESCRIPTION OF THE INVENTION

This can be achieved with systems as described in the opening paragraph if where the containers are connected in a cluster, and where all containers in the cluster are connected to the same sub power grid, and where at least some of the containers in the cluster are communicating with at least one cluster controller, which cluster controller is connected to at least one module for power line communication, which module comprises means for transmitting the modulated signal to and from the sub power grid. y only operating with a limited number of containers in the same cluster, a rather efficient communication is achieved. There will be a limited impairment of communication because only a limited number of containers will be connected over the power sub grid at the same time. In a situation where a critical failure occurs and where the communication is impossible because of electronic impairments, these systems would allow easy detection of the damaged cluster. Hereafter manual investigation of containers could be necessary, however only a limited number of containers have to be checked.

The module can transmit modulated signals from the cluster controller towards the containers, which module might comprise at least one magnetic core, which magnetic core surrounds at least one of the power lines, which magnetic core comprises a secondary winding, which secondary winding is connected to the cluster controller. It can hereby be achieved that there is no direct electrical connection to the power grid where the power lines pass through the module. In this way, a total galvanic isolation towards the power grid will exist, and as such this will protect the module and the cluster controller against a great part of the impairments that might exist on the power grid. These impairments could be high voltage sparks that otherwise could destroy or at least disturb the electronic circuit. Impairments could also be generated if a lot of refrigeration containers are connected to the same power grid and hence generating frequency dependent impairments. These frequency dependent impairments can disturb the communication over the whole system of containers, and these frequency dependent impairments can have a negative influence on the systems that communicate over the power lines. All these problems can easily be avoided if the systems operate with only magnetic transmission of signals to and from the power grid.

More cluster controllers can be communicating over normal data lines for achieving communication to all containers connected to different clusters. It is hereby achieved that the cluster controllers can be communicating with a control system. This allows a control system for example to search for a specific container, for example letting all clusters getting the information that a container with a specific code has to be found. If all containers are operating then this container should be found in a few minutes with an indication of the cluster in which it is connected. In operation, the control system can have a total overview of the number of containers that is connected to the grid. This period for searching a container takes place much faster compared to previous systems. All information from the containers about for example inside temperature and technical behaviour of each single refrigeration container can be communicated to the control system. This will help the personnel on board a ship or in the container yard because the manual checking of the containers may still be performed but the personnel knows what to look for probably before they start checking.

The module enables means for stopping the power line communication for transmission backwards in the power grid leading power towards the module. It is hereby achieved that the communication that is generated for one cluster can be short circuited so this communication is not being transmitted backwards into the power grid and further towards other clusters. In this way, impairments to the other clusters will not occur.

The module can further enable means for stopping the power line communication transmission over the power lines towards the module. It is hereby achieved that also impairments coming at critical frequencies which impairments also could be communication from another cluster are short circuited before entering the next cluster. This will lead to a very effective communication without impairments in the communication inside the cluster.

The invention further concerns methods for power line communication to and from containers where a number of containers can be connected to a power grid, where the methods perform communication with the containers, where the containers perform communication backwards, and where the communication to and from the containers is performed as modulated signals transmitted over the power grid, where the methods concern use of at least one module for power line communication, which module couples the modulated signal to and from the power grid, which modulation is performed by at least one magnetic core, which magnetic core surrounds the power lines, which magnetic core is magnetized by a secondary winding, which secondary winding is electronically activated by the cluster controller.

An effective power line communication to and from containers is hereby achieved which containers could be refrigeration containers on a ship or in a container yard. By achieving communication by means of a magnetic core, the communication is performed without any electrical connection towards the power grid. The modulated signals are transmitted into the power grid where all three-power lines contain exactly the same signal. This leads to no transmission between the three power lines, and the signals will flow in the power grid with limited impairments. In the module where the communication is generated, a galvanic isolation between the power grid and the communication systems is achieved. Because the communication is performed magnetically, voltage protection is performed simply because the signal transmission takes place over a kind of transformer. This transformer is preferably optimized for the correct signal.

The containers are preferably connected in a cluster, where all containers in the cluster are connected to the same sub power grid, where a cluster controller communicates with some or all containers in the cluster. By letting the containers operate in a cluster with a cluster controller talking care of the power lines distributed to all containers in a cluster, a very effective communication can be achieved inside this cluster because there will be limited impairments as the number of containers in the cluster is limited.

More cluster controllers can communicate over normal data lines for achieving communication to all containers connected to different clusters. The cluster controllers can communicate with each other or with a central computer system over the normal communication lines. A central computer system can hereby have the total control over the containers, for example on board a ship. All information available in each single container will be available for the central computer system. This means that the central computer system automatically can detect all refrigeration containers on board a ship, which are connected to a power grid. Furthermore, the computer system can get information about the actual status in the containers. Alarm signals can be transmitted automatically from a single container to the computer system, and personnel can be sent to a specific container immediately after a failure has occurred to investigate the refrigeration system in a container.

The methods also concern blocking for communication and impairments backwards and forwards from the clusters. It is hereby achieved that communication signals and impairments are not disturbing other clusters. Further electromagnetic disturbances can also be avoided in this way so the total communication in a cluster is performed very effectively.

### DETAILED DESCRIPTION OF THE INVENTION

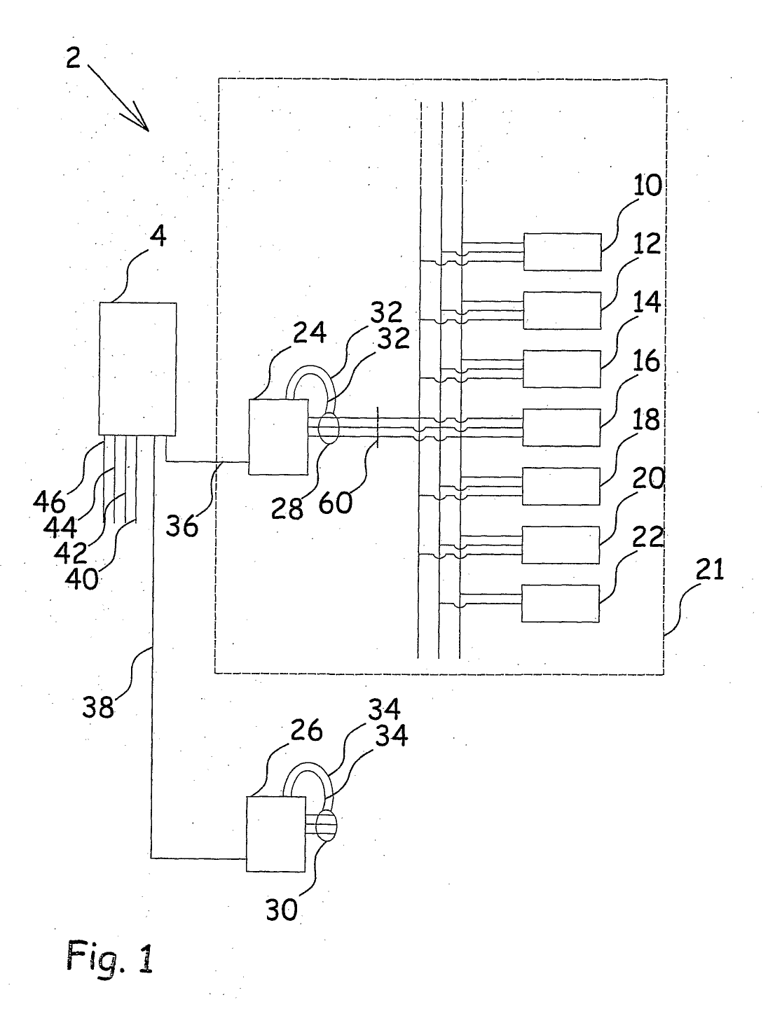

FIG. 1 describes systems 2 for communication with a number of containers 10-20 with a control system 4 comprising computer means. The control system 4 communicates over lines 36-46 with cluster controllers 24,26 where the cluster controller 24, 26 has lines 32,34 which communicate with a magnetic core 28,30. In the same way, the cluster controller 26 is connected by lines 34 with a magnetic core 28,30 The magnetic cores 28,30 surround the power lines 60 which power lines are distributed in parallel to the containers 10-20. As indicated, more containers than indicated in FIG. 1 could be connected to the same cluster controller 24,26.

It is foreseen that the containers 10-20 are equipped with communication means that can send or receive communication signals over the power lines 60. All intelligent containers, for example refrigeration containers, comprise computer means for controlling the refrigeration system. These containers also comprise computers which can take over the communication over the power lines 60. The cluster controller 24 or 26 is only communicating with the containers connected in the actual cluster. The cluster controllers 24,26 use magnetic cores 28,30 for communication to and from the power lines 60. A magnetic core 28,30 surrounds all three power lines, and magnetic induction into the power lines takes place where signals coming from the containers also indicate magnetic signals in the magnetic cores 28,30 which then operate as the receiver. By surrounding all three power lines with the same core, it is achieved that exactly the same signal is induced in each of the three power lines. In this way, there will be no disturbance between the power lines of signals flowing from one power line to another simply because the signal content of the power lines is equal. When the cluster controller 24 operates as a receiver, the magnetic core is so effective that if a container only communicates with one of the power lines, sufficient signal amplitude and quality will be received by the magnetic core 28 so that the signal will be accepted.

By placing a number of containers into clusters with separate communication, the impairments in the communication are avoided.

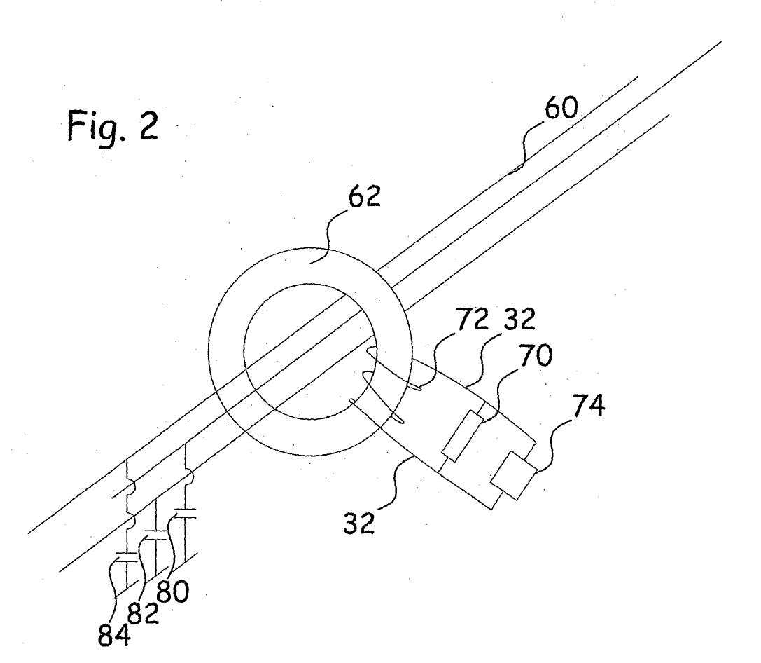

FIG. 2 shows the magnetic core 28 which could be a ferrite core typically with an AL value between 2,000 and 10,000 nH pr. winding. This core surrounds the power lines 60. The magnetic core 28 also comprises a secondary winding 72, which typically has between one and ten turns. This winding 72 is over lines 32 connected to a termination resistor 70 between 1-100 ohms, where the lines 32 further are connected to a signal connector 74. A filter is shown in the shape of capacitors 80, 82, 84, which capacitors are connected to each of the power lines 60. The capacitors are all connected to the ground, where the capacitors compared with the core 28 form a filter unit, which will filter out all communication signals and impairments coming over line 60 so that these signals or impairments are not transmitted further backwards in a power grid. Communication signals and impairments coming towards the core 28 will also be filtered out. The value of the capacitors 80, 82, 84 can be calculated in combination with the magnetic value of the core 28 so that all communication signals and impairments in the same frequency area will be short circuited by this circuit.

Very effective power line communication systems are hereby achieved where all power lines receive exactly the same information. It is to be understood that the number of power lines is not necessarily three. One power line is sufficient for the communication in very small systems, but also power lines with more phases than three could in practice be used because the magnetic core 28 only has to surround all the power lines. Also for systems using other frequencies than 50 or 60 Hertz, it should be possible to use systems like these. For example in the future, small containers placed in airplanes could be using a five or seven phase power line operating at a frequency of 400 Hertz or even higher.

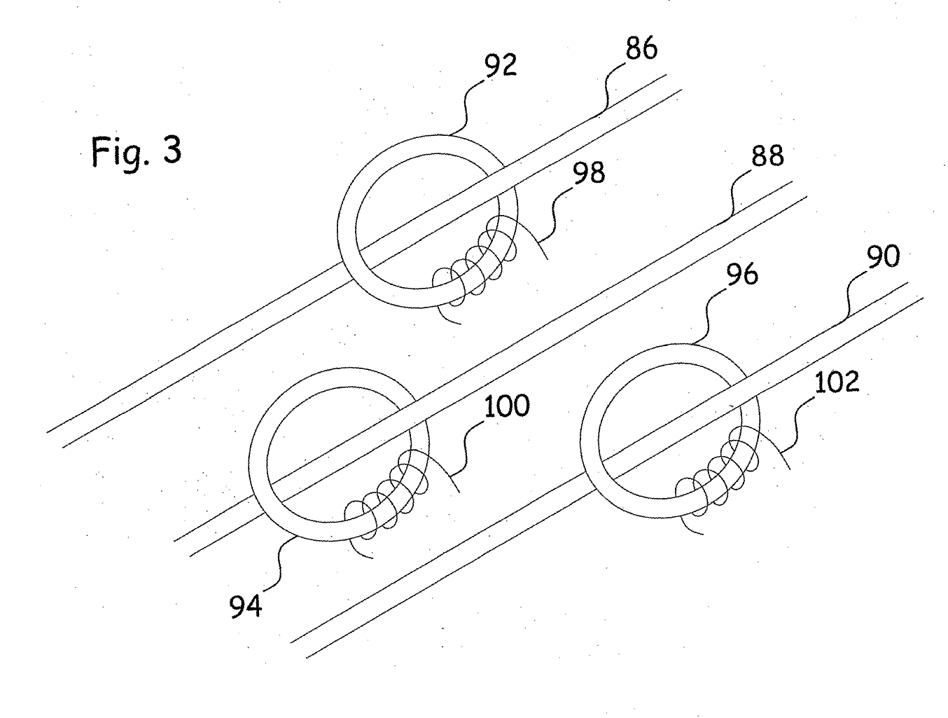

FIG. 3 shows an alternative embodiment showing three power lines 86,88,90 from a power grid. These power lines are each surrounded by a magnetic core 92,94,96. Each of these cores also comprises a winding 98,100,102.

FIG. 3 describes in this way an alternative embodiment where the cores 92,94,96 and the windings 98,100,102 can be connected so they are operating in parallel. In this way, all three power lines 86,88,90 in the power grid are carrying the same communication signal. The alternative embodiment in FIG. 3 can also be combined with capacitors as shown in FIG. 2

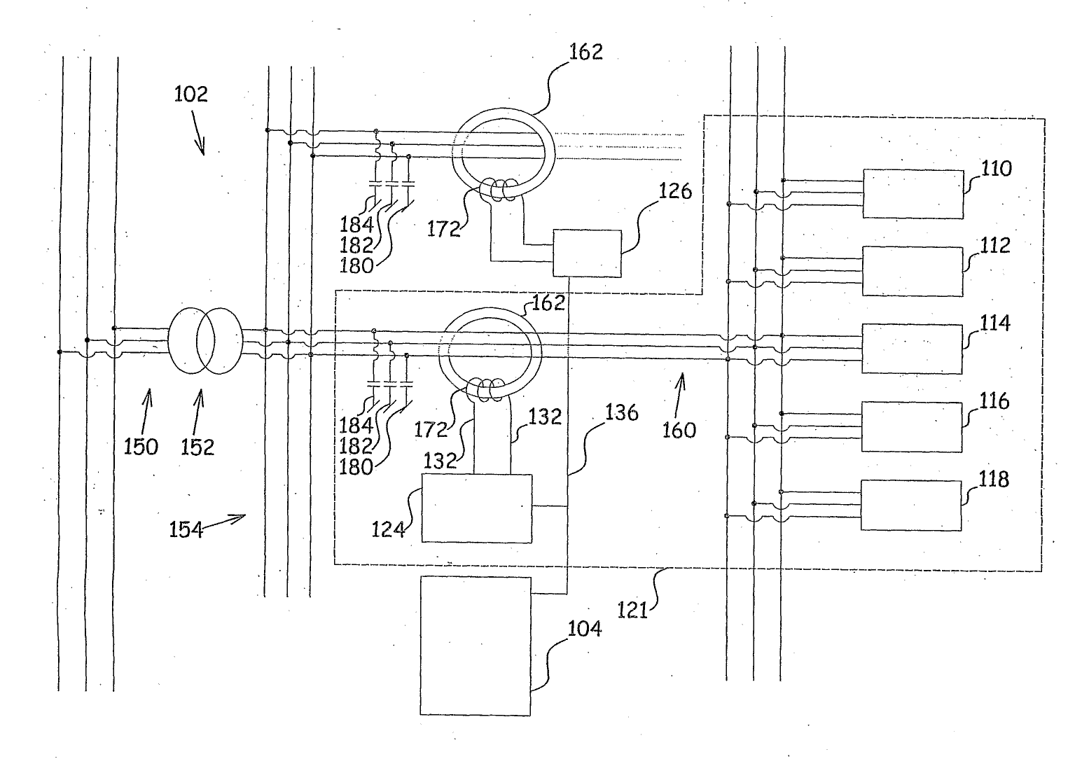

FIG. 4 shows an electrical supply and communication system for a number of consumers which e.g. could be refrigeration containers. The system 102 comprises computer means 104, which computer means could control a high number of refrigeration containers 101-118. These containers 110-118 all take part of a cluster 121. In the cluster 121 is indicated a cluster controller 124, which is in charge of the bidirectional communication between the containers 101-108 and the computer system 104 over line 136. FIG. 4 indicates a further cluster controller 126. The cluster controllers 124 and 126 have analogue communication lines 132 connected to a coil 172 wound around a magnetic core 162. High voltage power is supplied to the system over lines 150. Through a transformer 152 the voltage is reduced for the ordinary three-phase supply over a sub-grid 160. The lines in the sub-grid 160 are surrounded by the coils 162, which coil 162 magnetic induces electrical signals into the power lines. To isolate the communication unit a filter is formed. Capacitors 180, 182 and 184 are connected to the ground. If these capacitors have the correct electrical value, which value could be 100 nano Farad. This can lead to grounding of all signals at frequencies above a few kilohertz and hereby put a stop to all commutation signals in the filter.

This way a cluster 121 can operate as an isolated communication unit. The number of containers in a cluster could be as high as 2000 containers. For such a high number of containers it is very important that the electrical grid is free from other electrical communication signals or from the noise coming from the containers operating together. Therefore it might be very important in connection with large container ships or big container yards to connect the containers in clusters. The clusters will then operate as isolated communication units, which operate independently of the rest of the system. This way it should be possible for a central computer 104 to be in communication with all containers onboard a ship or in a container yard.

This invention could be used for power line communication in private homes, where houses or flats could be connected in a cluster.

1. Systems for power line communication primarily for refrigeration containers, where a number of containers are connected to a power grid, where the systems comprise means for bidirectional communication with at least some of the containers, where at least some of the containers comprise means for communication with the systems, where the communication to and from the containers is performed by modulation of a signal transmitted over the power grid, wherein the containers are connected in a cluster, where all containers in the cluster are connected to the same sub power grid, where at least some of the containers in a cluster are communicating with at least one cluster controller, which cluster controller are connected to at least one module for power line communication, which module comprises means for transmitting the modulated signal to and from the sub power grid.

2. Systems for power line communication according to claim 1, wherein the module transmits modulated signals from the cluster controller towards containers, which module comprises at least one magnetic core, which magnetic core surrounds at least one of the power lines, which magnetic core comprises a secondary winding, which secondary winding is connected to the cluster controller.

3. Systems for power line communication according to claim 2, wherein more cluster controllers are communicating over normal data lines for achieving communication to all containers connected to different clusters.

4. Systems for power line communication according to claim 3, wherein the module comprises means for stopping the power line communication for transmission backwards in the power lines leading power towards the module.

5. Methods for power line communication to and from containers,
where a number of containers are connected to a power grid, where the methods performs bidirectional communication with at least some of the containers,
where the communication to and from the containers is performed as modulation of a signal transmitted over the power grid, wherein the methods concern use of at least one cluster controller for power line communication, which cluster controller comprises means for transmitting the modulated signal to and from a sub power grid,
where the containers are connected in a cluster, where all containers in the cluster are connected to the same sub power grid, where a cluster controller communicates with at least some of the containers in the cluster.

6. Methods for power line communication according to claim 5, wherein the modulation is performed by at least one magnetic core, which magnetic core surrounds at least one of the power lines, which magnetic core is magnetized by a secondary winding, which secondary winding is electronically activated by a cluster controller.

7. Methods for power line communication according to claim 6, wherein more cluster controllers communicate over normal data lines for achieving communication to all containers connected to different clusters.

8. Methods for power line communication according to claim 7, wherein the methods also concern blocking for communication and impairments forwards and backwards from the clusters.
